(19) United States
(12) Patent Application Publication
(10) Pub. No.: US 2025/0293564 A1
(43) Pub. Date: Sep. 18, 2025

(54) ELECTRIC APPARATUS AND CONTROL METHOD OF ELECTRIC APPARATUS

(71) Applicant: HONDA MOTOR CO., LTD., Tokyo (JP)

(72) Inventor: Tsunehiro Kobayashi, Wako-shi (JP)

(21) Appl. No.: 19/037,314

(22) Filed: Jan. 27, 2025

(30) Foreign Application Priority Data
Mar. 12, 2024 (JP) 2024-038076

(51) Int. Cl. H02K 3/28; H02K 1/16; H02K 11/33

(52) U.S. Cl. CPC H02K 3/28; H02K 1/16; H02K 11/33

(57) ABSTRACT

An electric apparatus includes: an electric power storage device; a rotary electric machine; an electric power control unit; and an angle sensor that acquires a phase of a rotor of the rotary electric machine. The electric power control unit acquires a target DC component of a current that flows through the β-phase first coil and the β-phase second coil of the rotary electric machine by electric power supplied from an external AC electric power source in accordance with a stop phase of the rotor acquired by the angle sensor at the time of stopping of the rotary electric machine and charges the electric power storage device by an electric power conversion operation based on the target DC component.

### CROSS-REFERENCE TO RELATED APPLICATION

Priority is claimed on Japanese Patent Application No. 2024-038076, filed on Mar. 12, 2024, the contents of which are incorporated herein by reference.

### BACKGROUND

### Field of the Invention

The present invention relates to an electric apparatus and a control method of an electric apparatus.

### Background

In recent years, in order to ensure that more people have access to affordable, reliable, sustainable, and advanced energy, research and development relating to charging and electric power supply in a mobility on which a secondary battery is mounted, which contributes to energy efficiency, has been conducted.

In the related art, for example, electric vehicles are known which convert AC electric power supplied from an external electric power source into DC electric power by a combination of a stator winding of a plurality of phases of a motor and a bridge circuit of a plurality of phases by a switching element (for example, refer to Japanese Unexamined Patent Application, First Publication No. 2009-65808 and Japanese Unexamined Patent Application, First Publication No. 2021-5944). In these electric vehicles, in order to prevent a torque from being generated at the motor at the time of AC charging by the external electric power source, a control is performed such that a rotor position (rotation angle) at the time of stopping of the motor is a predetermined position.

### SUMMARY

In the technique relating to charging and electric power supply in a mobility on which a secondary battery is mounted, it is a problem to prevent generation of an impact sound of a gear caused by the torque generated at the motor at the time of AC charging by the external electric power source, that is, a so-called tooth striking sound. For example, as in the electric vehicle of the related art described above, when controlling the rotor position at the time of stopping of the motor to a predetermined position in advance, there is a possibility that an appropriate control of the rotor position becomes difficult due to the driver's intention, the surrounding environment, other controls in the vehicle, and the like. Further, even when the rotor position is set to the predetermined position, since the vibration of the rotor occurs depending on the frequency of the charging current at the time of AC charging, there is a possibility that the tooth striking sound of the gear connected to the rotor is generated.

The present application aims at achieving prevention of generation of an impact sound caused by the vibration of a rotor at the time of AC charging.

An electric apparatus (for example, an electric apparatus 10 in the embodiment) according to a first aspect of the present invention includes: an electric power storage device (for example, an electric power storage device 11 in the embodiment); a rotary electric machine (for example, a rotary electric machine 16 (M) in the embodiment) having a rotor (for example, a rotor 41 in the embodiment) and a plurality of coils (for example, a β-phase first coil 33 (β1) and a β-phase second coil 34 (β2) in the embodiment); an electric power control unit (for example, an electric power control unit 10a in the embodiment) that is connected to the electric power storage device and one or more of the plurality of coils and controls electric power transfer of each of the electric power storage device and the rotary electric machine; and a phase acquisition portion (for example, an angle sensor 51 in the embodiment) that acquires a phase of the rotor, wherein the electric power control unit acquires a target DC component of a current that flows through the coils by electric power supplied from an external electric power source in accordance with a stop phase of the rotor acquired by the phase acquisition portion at a time of stopping of the rotary electric machine and charges the electric power storage device by an electric power conversion operation based on the target DC component.

A second aspect is the electric apparatus according to the first aspect described above, wherein the one or more of the plurality of coils may form an AC electric power source input phase connected to an external AC electric power source, the electric apparatus may include an electric power source connection member (for example, an AC electric power source connection portion 15 in the embodiment) that connects the electric power control unit and the one or more of the plurality of coils to the external AC electric power source, and the electric power control unit may change the target DC component to an increase tendency in accordance with an increase of an angle between the AC electric power source input phase and a q-axis of the rotor.

A third aspect is the electric apparatus according to the first aspect described above which may include: a regulation mechanism (for example, a regulation mechanism 52 in the embodiment) that regulates power transmission in a power transmission mechanism connected to the rotor.

A fourth aspect is the electric apparatus according to any one of the first to third aspects described above, wherein the one or more of the plurality of coils may be a first phase coil (for example, a β-phase first coil 33 (β1) and a β-phase second coil 34 (β2) in the embodiment) that forms an AC electric power source input phase connected to an external AC electric power source, the plurality of coils may include a plurality of second phase coils (for example, an α-phase first coil 23 (α1) and an α-phase second coil 24 (α2) in the embodiment) that form a DC conversion phase used for conversion between DC electric power, and the electric power control unit may control the conversion between DC electric power by a combination with the plurality of second phase coils.

A fifth aspect is the electric apparatus according to the fourth aspect described above which may include: an electric power source connection member (for example, an AC electric power source connection portion 15 in the embodiment) that connects the electric power control unit and the one or more of the plurality of coils to an external AC electric power source, wherein the plurality of second phase coils may include an open-ended first coil (for example, an α-phase first coil 23 (α1) in the embodiment) and an open-ended second coil (for example, an α-phase second coil 24 (α2) in the embodiment), the rotary electric machine may include a stator core (for example, a stator core 42 in the embodiment) on which a slot (for example, a slot 43 in the embodiment) shared by the first coil and the second coil is formed, the electric power control unit may include: a first full-bridge circuit (for example, a first full-bridge circuit 12a in the embodiment) that is connected to both ends of the first coil; a second full-bridge circuit (for example, a second full-bridge circuit 12b in the embodiment) that is connected to both ends of the second coil; one or more third full-bridge circuits (for example, a third full-bridge circuit 13a and a fourth full-bridge circuit 13b in the embodiment) that are connected to both ends of one or more first phase coils; a first connection-disconnection device (for example, a first connection-disconnection device 25 in the embodiment) that is connected between positive electrodes of the first full-bridge circuit and the second full-bridge circuit; a second connection-disconnection device (for example, a second connection-disconnection device 26 in the embodiment) that is connected between negative electrodes of the first full-bridge circuit and the second full-bridge circuit; and at least one third connection-disconnection device (for example, a third connection-disconnection device 35 and a fourth connection-disconnection device 36 in the embodiment) that is connected between one end of the one or more first phase coils and the one or more third full-bridge circuits, and the electric power source connection member may be connected to both ends of the third connection-disconnection device.

An electric apparatus control method according to a sixth aspect of the present invention is a control method of an electric apparatus (for example, an electric apparatus 10 in the embodiment) that includes: an electric power storage device (for example, an electric power storage device 11 in the embodiment); a rotary electric machine (for example, a rotary electric machine 16 (M) in the embodiment) having a rotor (for example, a rotor 41 in the embodiment) and a plurality of coils (for example, a β-phase first coil 33 (β1) and a β-phase second coil 34 (β2) in the embodiment); an electric power control unit (for example, an electric power control unit 10a in the embodiment) that is connected to the electric power storage device and one or more of the plurality of coils and controls electric power transfer of each of the electric power storage device and the rotary electric machine; and a phase acquisition portion (for example, an angle sensor 51 in the embodiment) that acquires a phase of the rotor, the electric apparatus control method including: when electric power is supplied to the electric power storage device via the one or more of the plurality of coils and the electric power control unit from an external AC electric power source, acquiring a stop phase of the rotor at a time of stopping of the rotary electric machine by the phase acquisition portion (for example, Step S01 in the embodiment); acquiring a target DC component superposed on a target current of a current that flows through the coils by electric power supplied from the external AC electric power source in accordance with the stop phase of the rotor (for example, Step S05 in the embodiment); and charging the electric power storage device by an electric power conversion operation based on the target current on which the target DC component is superposed (for example, Step S06 in the embodiment).

According to the first aspect described above, in the case of a stop phase in which positive and negative torques are largely generated at the rotor in a state where an AC current is supplied to the coil of the rotary electric machine, by providing an offset in a current value, it is possible to prevent generation of an impact sound such as a tooth striking sound of a gear due to torque pulsation. On the other hand, in the case of a stop phase in which positive and negative torques are not largely generated at the rotor, by not providing an offset in a current value, it is possible to prevent a decrease of charging efficiency without increasing a current effective value.

In the case of the second aspect described above, it is possible to prevent generation of an impact sound such as a tooth striking sound of a gear due to torque pulsation caused by the supply of an AC current to part of the phases of the rotary electric machine.

In the case of the third aspect described above, by including the regulation mechanism, it is possible to prevent generation of rotation caused by the target DC component at the power transmission mechanism connected to the rotor.

In the case of the fourth aspect described above, it is possible to convert a rectified DC voltage and charge the electric power storage device, and, for example, in the case of a voltage increase operation, it is possible to perform rapid charging with respect to the voltage of the electric power storage device that is larger than the charging voltage by the external electric power source.

In the case of the fifth aspect described above, at the time of driving of the rotary electric machine by the electric power storage device, it is possible to perform a function as an inverter of a multiple full-bridge circuit. At the time of AC charging of the electric power storage device by the external AC electric power source, the combination of the first coil and the second coil of the rotary electric machine, the first full-bridge circuit, and the second full-bridge circuit can function as an insulation-type bidirectional DC-DC converter, and the combination of the first phase coil and the third full-bridge circuit can function as a rectification circuit. For example, in the case of the voltage increase operation at the time of AC charging, it is possible to perform rapid charging with respect to the voltage of the electric power storage device that is larger than the charging voltage by the external AC electric power source.

According to the sixth aspect described above, in the case of a stop phase in which positive and negative torques are largely generated at the rotor in the state where an AC current is supplied to the coil of the rotary electric machine, by providing an offset in a current value, it is possible to prevent generation of an impact sound such as a tooth striking sound of a gear due to torque pulsation. On the other hand, in the case of a stop phase in which positive and negative torques are not largely generated at the rotor, by not providing an offset in a current value, it is possible to prevent a decrease of charging efficiency without increasing a current effective value.

### BRIEF DESCRIPTION OF THE DRAWINGS

FIG. 1 is a view showing the configuration of an electric apparatus of an embodiment of the present invention.

FIG. 2 is a configuration view of each full-bridge circuit and a rotary electric machine in the electric apparatus of the embodiment of the present invention.

FIG. 3 is a view showing a configuration of part of the electric apparatus of the embodiment of the present invention.

FIG. 4 is a graph view showing an example of a correspondence relationship between a rotor phase and each of a torque amplitude and an average torque when there is no superposition of a target DC component at the time of AC charging in the electric apparatus of the embodiment of the present invention.

FIG. 5 is a graph view showing an example of a time change of a torque of a drive shaft in each of the embodiment of the present invention and a comparative example.

FIG. 6 is a flowchart showing an operation of the electric apparatus in the embodiment of the present invention.

FIG. 7 is a configuration view of a rotary electric machine of an electric apparatus in a modification example of the embodiment of the present invention.

### DESCRIPTION OF EMBODIMENTS

Hereinafter, an electric apparatus according to an embodiment of the present invention will be described with reference to the accompanying drawings.

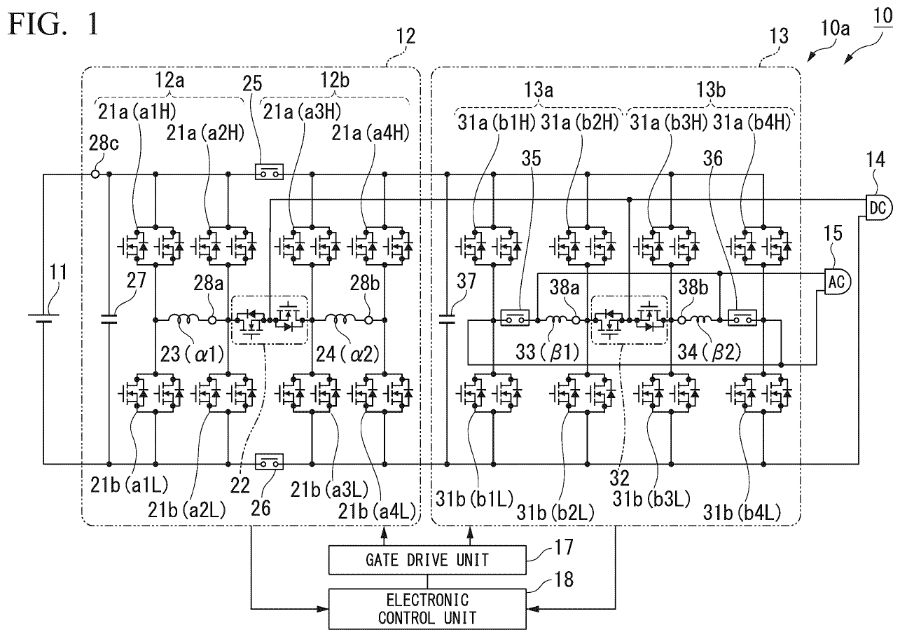

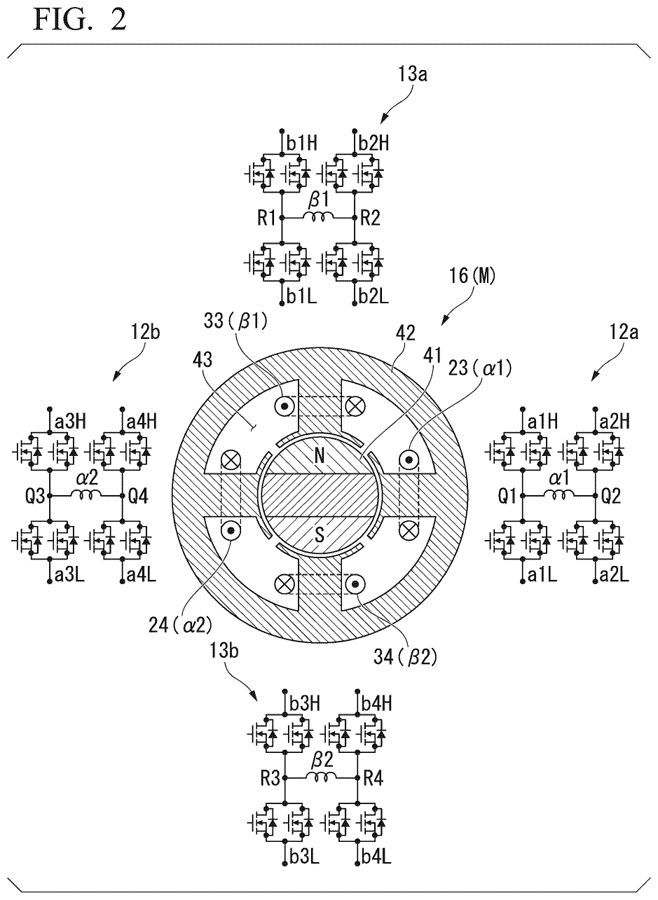

FIG. 1 is a view showing the configuration of an electric apparatus 10 of an embodiment. FIG. 2 is a configuration view of full-bridge circuits 12a, 12b, 13a, 13b and a rotary electric machine 16 in the electric apparatus 10 of the embodiment.

The electric apparatus 10 of the embodiment is mounted, for example, on an electric vehicle, an electric movable body, an electric machine, an electric power source apparatus, and the like. The electric vehicle is, for example, an electric automobile that includes a rotary electric machine as a power source, a saddle riding vehicle, a kick skater, a hybrid vehicle by a combination of a rotary electric machine and an internal combustion engine, a fuel cell vehicle by a combination of an electric power storage device and a fuel cell, and the like. The electric movable body is, for example, a robot, a flying vehicle, a movable body on water, an underwater movable body, and the like. The electric machine is, for example, a construction machinery that includes a rotary electric machine as a power source and the like. The electric power source apparatus is, for example, a stationary or mobile electric power source apparatus that performs discharging and charging of an electric power storage device and the like.

### Electric Apparatus

As shown in FIG. 1 and FIG. 2, the electric apparatus 10 of the embodiment includes, for example, an electric power storage device 11, a first electric power conversion portion 12, a second electric power conversion portion 13, a DC electric power source connection portion 14, an AC electric power source connection portion 15 (electric power source connection member), a rotary electric machine 16 (M), a gate drive unit 17, and an electronic control unit 18. For example, the first electric power conversion portion 12, the second electric power conversion portion 13, the DC electric power source connection portion 14, the AC electric power source connection portion 15, the gate drive unit 17, and the electronic control unit 18 constitute an electric power control unit 10a.

The electric power storage device 11 is connected to the first electric power conversion portion 12 and the second electric power conversion portion 13 described later.

The electric power storage device 11 includes, for example, a plurality of battery cells that are connected in series or in parallel. Each battery cell is, for example, a lead storage battery, a lithium-ion battery, a secondary battery such as a nickel hydride battery and an all-solid-state battery, a capacitor such as an electric double layer capacitor, a compound battery by a combination of a secondary battery and a capacitor, or the like. Each battery cell repeatedly performs charging and discharging. The electric power storage device 11 transfers electric power to and from the rotary electric machine 16 via the electric power control unit 10a. The electric power storage device 11 is charged by an external electric power source (an external DC electric power source and an external AC electric power source).

The first electric power conversion portion 12 includes a first full-bridge circuit 12a and a second full-bridge circuit 12b.

Each of the first full-bridge circuit 12a and the second full-bridge circuit 12b includes, for example, a so-called H-bridge circuit formed of a plurality of switching elements connected in two phases by bridge connection. Each switching element is, for example, a transistor of a SiC (Silicon Carbide) or the like, such as a MOSFET (Metal Oxide Semi-conductor Field Effect Transistor) or an IGBT (Insulated Gate Bipolar Transistor). Each switching element is, for example, an N-channel type MOSFET.

The plurality of switching elements are, for example, a pair of transistors forming each of high-side arm and low-side arm element portions 21a, 21b that form a pair in each phase. Each pair of transistors of each element portion 21a, 21b are connected, for example, in parallel.

Each full-bridge circuit 12a, 12b may include, for example, a rectifier element such as a reflux diode which is connected in parallel between a collector and an emitter of each transistor in a forward direction toward the collector from the emitter.

The first electric power conversion portion 12 includes, for example, a first switch 22 connected between neutral points Q2, Q3 of the first full-bridge circuit 12a and the second full-bridge circuit 12b. The neutral point Q2 of the first full-bridge circuit 12a is, for example, a connection point between a high-side arm element portion 21a (a2H) and a low-side arm element portion 21b (a2L) that are connected in series in a second phase among first and second phases of two phases of the first full-bridge circuit 12a. For example, the neutral point Q2 is a connection point between a source of the high-side arm element portion 21a (a2H) and a drain of the low-side arm element portion 21b (a2L). The neutral point Q3 of the second full-bridge circuit 12b is, for example, a connection point between a high-side arm element portion 21a (a3H) and a low-side arm element portion 21b (a3L) that are connected in series in a first phase among first and second phases of two phases of the second full-bridge circuit 12b. For example, the neutral point Q3 is a connection point between a source of the high-side arm element portion 21a (a3H) and a drain of the low-side arm element portion 21b (a3L).

The first switch 22 is, for example, a bidirectional switch formed of two switching elements. Each switching element is a transistor such as a MOSFET or an IGBT and is, for example, an N-channel type MOSFET. The first switch 22 includes, for example, two transistors connected reversely in series. For example, the sources of the two transistors are connected to each other, and thereby, the two transistors are connected in series in a direction opposite to each other. The first switch 22 switches conduction and cutoff of a current between the neutral points Q2, Q3 by ON (conduction)/OFF (cutoff) of the two transistors.

Each transistor may include a rectifier element such as a reflux diode which is connected in parallel between a collector and an emitter in a forward direction toward the collector from the emitter.

The first electric power conversion portion 12 is connected to an a-phase first coil 23 (α1) and an α-phase second coil 24 (α2) of the rotary electric machine 16 described later. The α-phase first coil 23 is connected between neutral points Q1, Q2 of the first full-bridge circuit 12a. The α-phase second coil 24 (α2) is connected between neutral points Q3, Q4 of the second full-bridge circuit 12b. The neutral point Q1 of the first full-bridge circuit 12a is, for example, a connection point between a high-side arm element portion 21a (a1H) and a low-side arm element portion 21b (a1L) that are connected in series in the first phase of the first full-bridge circuit 12a. For example, the neutral point Q1 is a connection point between a source of the high-side arm element portion 21a (a1H) and a drain of the low-side arm element portion 21b (a1L). The neutral point Q4 of the second full-bridge circuit 12b is, for example, a connection point between a high-side arm element portion 21a (a4H) and a low-side arm element portion 21b (a4L) that are connected in series in the second phase of the second full-bridge circuit 12b. For example, the neutral point Q4 is a connection point between a source of the high-side arm element portion 21a (a4H) and a drain of the low-side arm element portion 21b (a4L).

The first electric power conversion portion 12 includes a first connection-disconnection device 25 connected between positive electrodes of the first full-bridge circuit 12a and the second full-bridge circuit 12b and a second connection-disconnection device 26 connected between negative electrodes of the first full-bridge circuit 12a and the second full-bridge circuit 12b.

Each of the first connection-disconnection device 25 and the second connection-disconnection device 26 is, for example, a contactor and switches between ON (conduction) and OFF (cutoff) of the connection between the first full-bridge circuit 12a and the second full-bridge circuit 12b.

The first electric power conversion portion 12 includes, for example, a capacitor (condenser) 27 connected between the positive electrode and the negative electrode. For example, the capacitor 27 smooths voltage variation generated in accordance with a switching operation between ON (conduction) and OFF (cutoff) of each switching element of the first electric power conversion portion 12.

The first electric power conversion portion 12 includes, for example, a first current sensor 28a arranged between the α-phase first coil 23 (α1) and the neutral point Q2, a second current sensor 28b arranged between the a-phase second coil 24 (α2) and the neutral point Q4, and a third current sensor 28c arranged between the electric power storage device 11 and the first electric power conversion portion 12.

For example, the first current sensor 28a detects a current that flows through the α-phase first coil 23 (α1). The second current sensor 28b detects a current that flows through the a-phase second coil 24 (α2).

The third current sensor 28c detects a current that flows between the first electric power conversion portion 12 and the electric power storage device 11.

The second electric power conversion portion 13 includes a third full-bridge circuit 13a and a fourth full-bridge circuit 13b.

Each of the third full-bridge circuit 13a and the fourth full-bridge circuit 13b includes, for example, a so-called H-bridge circuit formed of a plurality of switching elements connected in two phases by bridge connection. Each switching element is, for example, a transistor of a SiC or the like, such as a MOSFET or an IGBT. Each switching element is, for example, an N-channel type MOSFET.

The plurality of switching elements are, for example, a pair of transistors forming each of high-side arm and low-side arm element portions 31a, 31b that form a pair in each phase. Each pair of transistors of each element portion 31a, 31b are connected, for example, in parallel.

Each full-bridge circuit 13a, 13b may include, for example, a rectifier element such as a reflux diode which is connected in parallel between a collector and an emitter of each transistor in a forward direction toward the collector from the emitter.

The second electric power conversion portion 13 includes, for example, a second switch 32 connected between neutral points R2, R3 of the third full-bridge circuit 13a and the fourth full-bridge circuit 13b. The neutral point R2 of the third full-bridge circuit 13a is, for example, a connection point between a high-side arm element portion 31a (b2H) and a low-side arm element portion 31b (b2L) that are connected in series in a second phase among first and second phases of two phases of the third full-bridge circuit 13a. For example, the neutral point R2 is a connection point between a source of the high-side arm element portion 31a (b2H) and a drain of the low-side arm element portion 31b (b2L). The neutral point R3 of the fourth full-bridge circuit 13b is, for example, a connection point between a high-side arm element portion 31a (b3H) and a low-side arm element portion 31b (b3L) that are connected in series in a first phase among first and second phases of two phases of the fourth full-bridge circuit 13b. For example, the neutral point R3 is a connection point between a source of the high-side arm element portion 31a (b3H) and a drain of the low-side arm element portion 31b (b3L).

The second switch 32 is, for example, a bidirectional switch formed of two switching elements. Each switching element is a transistor such as a MOSFET or an IGBT and is, for example, an N-channel type MOSFET. The second switch 32 includes, for example, two transistors connected reversely in series. For example, the sources of the two transistors are connected to each other, and thereby, the two transistors are connected in series in a direction opposite to each other. The second switch 32 switches conduction and cutoff of a current between the neutral points R2, R3 by ON (conduction)/OFF (cutoff) of the two transistors.

Each transistor may include a rectifier element such as a reflux diode which is connected in parallel between a collector and an emitter in a forward direction toward the collector from the emitter.

The second electric power conversion portion 13 is connected to a β-phase first coil 33 (β1) and a β-phase second coil 34 (β2) of the rotary electric machine 16 described later. The β-phase first coil 33 is connected between neutral points R1, R2 of the third full-bridge circuit 13a. The β-phase second coil 34 (β2) is connected between neutral points R3, R4 of the fourth full-bridge circuit 13b. The neutral point R1 of the third full-bridge circuit 13a is, for example, a connection point between a high-side arm element portion 31a (b1H) and a low-side arm element portion 31b (b1L) that are connected in series in the first phase of the third full-bridge circuit 13a. For example, the neutral point R1 is a connection point between a source of the high-side arm element portion 31a (b1H) and a drain of the low-side arm element portion 31b (b1L). The neutral point R4 of the fourth full-bridge circuit 13b is, for example, a connection point between a high-side arm element portion 31a (b4H) and a low-side arm element portion 31b (b4L) that are connected in series in the second phase of the fourth full-bridge circuit 13b. For example, the neutral point R4 is a connection point between a source of the high-side arm element portion 31a (b4H) and a drain of the low-side arm element portion 31b (b4L).

The second electric power conversion portion 13 includes a third connection-disconnection device 35 connected between one end of the β-phase first coil 33 (β1) and the third full-bridge circuit 13a and a fourth connection-disconnection device 36 connected between one end of the β-phase second coil 34 (β2) and the fourth full-bridge circuit 13b.

Each of the third connection-disconnection device 35 and the fourth connection-disconnection device 36 is, for example, a contactor. The third connection-disconnection device 35 is connected, for example, between the one end of the β-phase first coil 33 (β1) and the neutral point R1 of the first phase of the third full-bridge circuit 13a and switches between ON (conduction) and OFF (cutoff) of the connection between the β-phase first coil 33 (β1) and the neutral point R1. The fourth connection-disconnection device 36 is connected, for example, between the one end of the β-phase second coil 34 (β2) and the neutral point R4 of the second phase of the fourth full-bridge circuit 13b and switches between ON (conduction) and OFF (cutoff) of the connection between the β-phase second coil 34 (β2) and the neutral point R4.

The second electric power conversion portion 13 includes, for example, a capacitor (condenser) 37 connected between the positive electrode and the negative electrode. For example, the capacitor 37 smooths voltage variation generated in accordance with a switching operation between ON (conduction) and OFF (cutoff) of each switching element of the second electric power conversion portion 13.

The second electric power conversion portion 13 includes, for example, a fourth current sensor 38a arranged between the β-phase first coil 33 (β1) and the neutral point R2 and a fifth current sensor 38b arranged between the β-phase second coil 34 (β2) and the neutral point R4.

For example, the fourth current sensor 38a detects a current that flows through the β-phase first coil 33 (β1). The fifth current sensor 38b detects a current that flows through the β-phase second coil 34 (β2).

The DC electric power source connection portion 14 and the AC electric power source connection portion 15 include, for example, a connection device (connector) or the like for DC electric power and for AC electric power of a predetermined standard. The DC electric power source connection portion 14 and the AC electric power source connection portion 15 are connected, for example, to a DC electric power source (external DC electric power source) and an AC electric power source (external AC electric power source) at the outside on the basis of a commercial electric power source or the like connected to an electric power system.

The DC electric power source connection portion 14 is connected, for example, to the negative electrode of the second electric power conversion portion 13 and to a neutral point (that is, a point between the two transistors connected reversely in series) of each of the first switch 22 and the second switch 32.

The AC electric power source connection portion 15 is connected, for example, to each of the first neutral point R1 and the fourth neutral point R4 of the second electric power conversion portion 13 and to each of the connection point between the β-phase first coil 33 (β1) and the third connection-disconnection device 35 and the connection point between the β-phase second coil 34 (β2) and the fourth connection-disconnection device 36.

The rotary electric machine 16 (M) is, for example, a two-phase AC brushless DC motor. The rotary electric machine 16 includes, for example, the α-phase first coil 23 (α1), the α-phase second coil 24 (α2), the β-phase first coil 33 (β1), the β-phase second coil 34 (β2), a rotor 41, and a stator core 42.

The rotor 41 includes a field permanent magnet. Each coil α1, α2, β1, β2 that generates a rotating magnetic field which rotates the rotor 41 is attached to the stator core 42.

The α-phase first coil 23 (α1), the a-phase second coil 24 (α2), the β-phase first coil 33 (β1), and the β-phase second coil 34 (β2) are so-called open-ended coils, and ends of the coils α1, α2, β1, β2 are not connected to each other (that is, the coils α1, α2, β1, β2 are separated from each other) and are drawn out to the outside of the rotary electric machine 16.

The α-phase first coil 23 (α1) and the α-phase second coil 24 (α2) set, for example, a spatial phase difference from each other to be zero and are wound with respect to the different teeth of the stator core 42 in the same direction. The a-phase first coil 23 (α1) and the a-phase second coil 24 (α2) are arranged, for example, so as to share part of a slot 43 formed in the stator core 42 and are magnetically coupled to each other in the same polarity.

The β-phase first coil 33 (β1) and the β-phase second coil 34 (β2) set, for example, a spatial phase difference from each other to be zero and are wound with respect to the different teeth of the stator core 42 in the same direction. The β-phase first coil 33 (β1) and the β-phase second coil 34 (β2) are arranged, for example, so as to share part of the slot 43 formed in the stator core 42 and are magnetically coupled to each other in the same polarity.

The α-phase first coil 23 (α1), the α-phase second coil 24 (α2), the β-phase first coil 33 (β1), and the β-phase second coil 34 (β2) are arranged such that the α-phase first coil 23 (α1) and the α-phase second coil 24 (α2) do not magnetically interfere with the β-phase first coil 33 (β1) and the β-phase second coil 34 (β2) by setting the spatial phase difference from each other to be 90°.

For example, each coil α1, α2, β1, β2 is attached to the stator core 42 by concentrated winding, distributed winding, or the like, and the coils α1, α2, β1, β2 have the same number of winding as one another.

The rotary electric machine 16 (M) generates rotation power by performing a power running operation using electric power supplied from the first electric power conversion portion 12 and the second electric power conversion portion 13. For example, when the rotary electric machine 16 (M) is connected to a wheel of the vehicle, the rotary electric machine 16 (M) generates a travel drive force by the electric power supplied from the first electric power conversion portion 12 and the second electric power conversion portion 13. The rotary electric machine 16 (M) may generate electric power by performing a regeneration operation using rotation power input from the wheel side of the vehicle. For example, when the rotary electric machine 16 (M) is connected to the internal combustion engine of the vehicle, the rotary electric machine 16 (M) may generate electric power using the power of the internal combustion engine.

The gate drive unit 17 switches between ON (conduction) and OFF (cutoff) of each connection-disconnection device 25, 26, 35, 36 and each switching element of the first electric power conversion portion 12 and the second electric power conversion portion 13 on the basis of a control signal received from the electronic control unit 18. For example, the gate drive unit 17 switches between ON (conduction) and OFF (cutoff) of each switching element of each full-bridge circuit 12a, 12b, 13a, 13b by outputting a gate signal generated by amplification, level shift, and the like of the control signal.

The electronic control unit 18 integrally controls an operation of each of the electric power control unit 10a and the rotary electric machine 16 (M). For example, the electronic control unit 18 is a software function unit that functions by a predetermined program being executed by a processor such as a CPU (Central Processing Unit). The software function unit is an ECU (Electronic Control Unit) that includes the processor such as a CPU, a ROM (Read Only Memory) that stores the program, a RAM (Random Access Memory) that temporarily stores data, and an electronic circuit such as a timer. At least part of the electronic control unit 18 may be an integrated circuit such as a LSI (Large Scale Integration).

The electronic control unit 18 generates a control signal indicating a timing when each connection-disconnection device 25, 26, 35, 36 and each switching element of the first electric power conversion portion 12 and the second electric power conversion portion 13 are driven to ON (conduction) and OFF (cutoff). The electronic control unit 18 inputs the generated control signal to the gate drive unit 17.

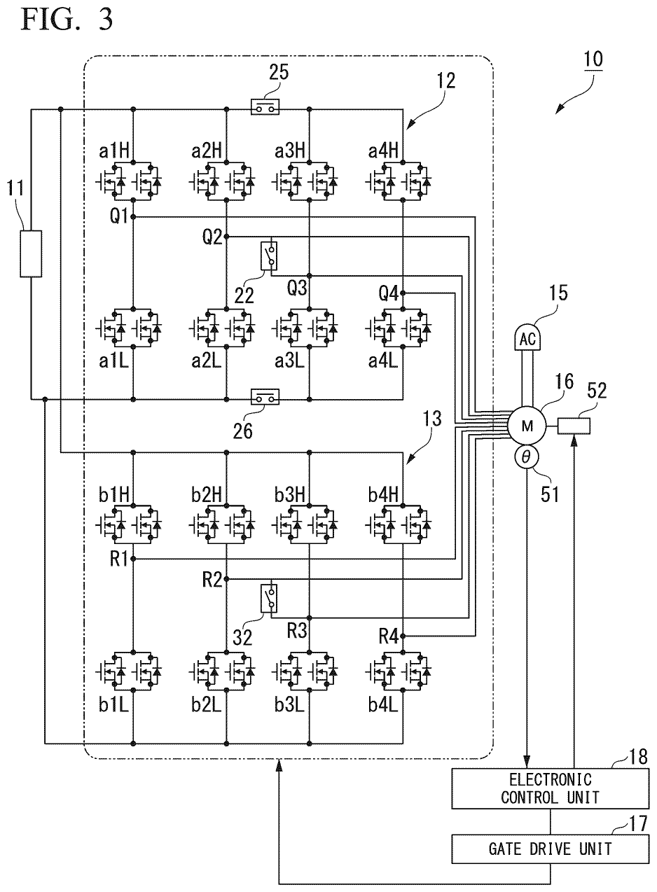

FIG. 3 is a view showing the configuration of part of the electric apparatus 10 of the embodiment.

As shown in FIG. 1, FIG. 2, and FIG. 3, the electric apparatus 10 includes, for example, an angle sensor 51 (phase acquisition portion) that detects a phase (rotation angle) θ of the rotor 41 of the rotary electric machine 16 (M), and a regulation mechanism 52 that regulates power transmission in a power transmission mechanism connected to the rotor 41. The regulation mechanism 52 is, for example, an electric parking brake and a parking lock mechanism in a vehicle, or the like.

### Control Operation of Electric Apparatus

The electronic control unit 18 sets the first connection-disconnection device 25 and the second connection-disconnection device 26 to an ON (conduction) state in the case of the power running operation or the regeneration operation of the rotary electric machine 16 (M). The electronic control unit 18 switches between a state in which the α-phase coils α1, α2 are connected in series and the β-phase coils β1, β2 are connected in series, and a state in which the α-phase coils α1, α2 are connected in parallel and the β-phase coils β1, β2 are connected in parallel by the switching between ON (conduction) and OFF (cutoff) of the first switch 22 and the second switch 32.

The electronic control unit 18 performs, for example, a feedback control or the like of a current in which a current detection value of the rotary electric machine 16 (M) and a current target value in response to a torque command value of the rotary electric machine 16 (M) are used and generates a control signal that commands the driving of each switching element of the first electric power conversion portion 12 and the second electric power conversion portion 13.

At the time of DC charging, that is, when the electric power storage device 11 is charged by the external DC electric power source connected to the DC electric power source connection portion 14, the electronic control unit 18 sets the first connection-disconnection device 25 and the second connection-disconnection device 26 to be in an ON (conduction) state. The electronic control unit 18 causes each of the combination of the α-phase coils α1, α2 and the first electric power conversion portion 12 and the combination of the β-phase coils β1, β2 and the second electric power conversion portion 13 to function as a non-insulation type DC-DC converter that performs a voltage increase operation by a so-called chopper control, for example, with respect to the external DC electric power source having a lower voltage than that of the electric power storage device 11.

At the time of AC charging, that is, when the electric power storage device 11 is charged by the external AC electric power source connected to the AC electric power source connection portion 15, the electronic control unit 18 sets the first connection-disconnection device 25 and the second connection-disconnection device 26 to be in an OFF (cutoff) state for insulation.

The electronic control unit 18 sets, for example, the a-phase first coil 23 (α1) and the α-phase second coil 24 (α2) that are magnetically coupled to each other in the same polarity to be a coil of a DC conversion phase (αphase) used for conversion between DC electric power. The electronic control unit 18 causes, for example, the combination of the α-phase coils α1, α2 and the first electric power conversion portion 12 to function as a DAB (Dual Active Bridge) type DC-DC converter which is an insulation-type bidirectional (voltage increase and voltage decrease) converter.

The electronic control unit 18 sets, for example, the β-phase first coil 33 (β1) and the β-phase second coil 34 (β2) that are magnetically coupled to each other in the same polarity to be a coil of an AC electric power source input phase (β phase) connected to the external AC electric power source. The electronic control unit 18 causes, for example, the combination of the β-phase coils β1, β2 and the second electric power conversion portion 13 to function as a so-called full-bridgeless type (or bridgeless and totem pole type) power factor correction (PFC) circuit which converts AC electric power into DC electric power. The so-called bridgeless PFC is a PFC that does not include a bridge rectifier by a plurality of diodes which are connected by bridge connection. The so-called totem pole PFC is a PFC that includes a pair of switching elements of the same conductivity type which are connected (totem pole connection) in series in the same direction. The electronic control unit 18 performs the power factor correction of an input voltage Vac and an input current Iac while performing rectification of AC electric power received from the external AC electric power source into DC electric power and increasing the voltage, for example, by controlling the switching of each switching element in each full-bridge circuit 13a, 13b of the second electric power conversion portion 13.

The electronic control unit 18 acquires a target DC component superposed on a target charging current of a current that flows through the β-phase first coil 33 (β1) and the β-phase second coil 34 (β2) from the external AC electric power source on the basis of a stop phase (stop angle) of the rotor 41 acquired by the angle sensor 51 with respect to the rotary electric machine 16 (M) during stopping at the time of AC charging. The target DC component is set, for example, on the basis of the stop phase (stop angle) of the rotor 41 and the target charging current and prohibits an average torque of the rotor 41 from becoming a value around zero.

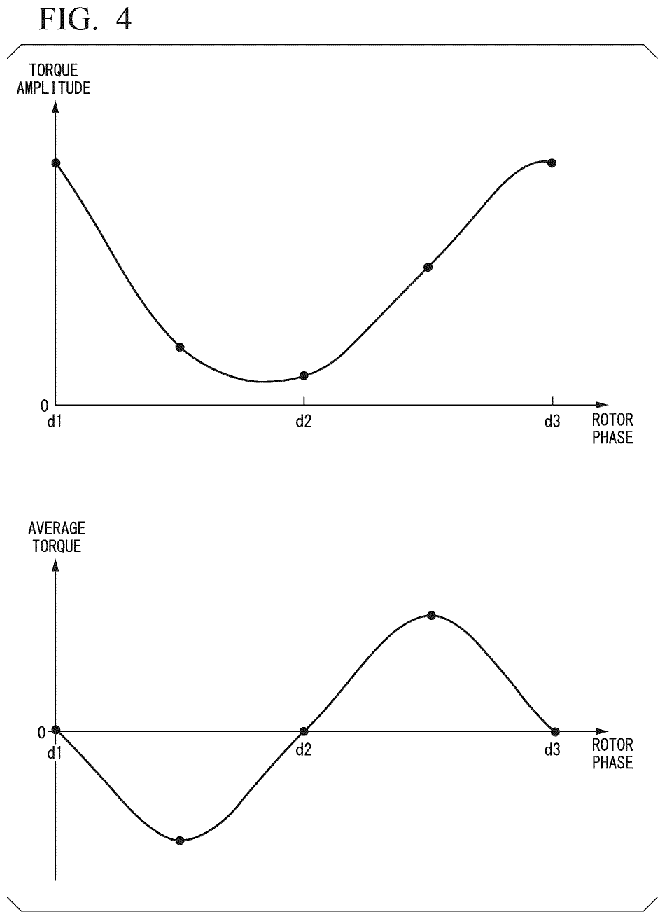

FIG. 4 is a graph view showing an example of a correspondence relationship between a rotor phase and each of a torque amplitude and an average torque when there is no superposition of a target DC component at the time of AC charging in the electric apparatus 10 of the embodiment. The torque amplitude and the average torque of the rotor 41 shown in FIG. 4 corresponds, for example, to a predetermined target charging current in the case where the efficiency of AC charging is maximized or the like.

As shown in FIG. 4, the average torque is, for example, an average value of a torque generated at the rotor 41 when the charging current flows from the external AC electric power source to the β-phase coils 33 (β1), 34 (β2) and is changed in accordance with the charging current and the stop phase of the rotor 41. For example, as shown in a first stop phase d1, a second stop phase d2, and a third stop phase d3, when the average torque becomes a value around zero, inversion of the torque is generated by the vibration of the rotor 41.

For example, when the average torque in accordance with the stop phase (stop angle) of the rotor 41 and the target charging current becomes a value around zero, the electronic control unit 18 causes the target DC component in accordance with the stop phase (stop angle) of the rotor 41, the target charging current, and the like to be superposed on the target charging current.

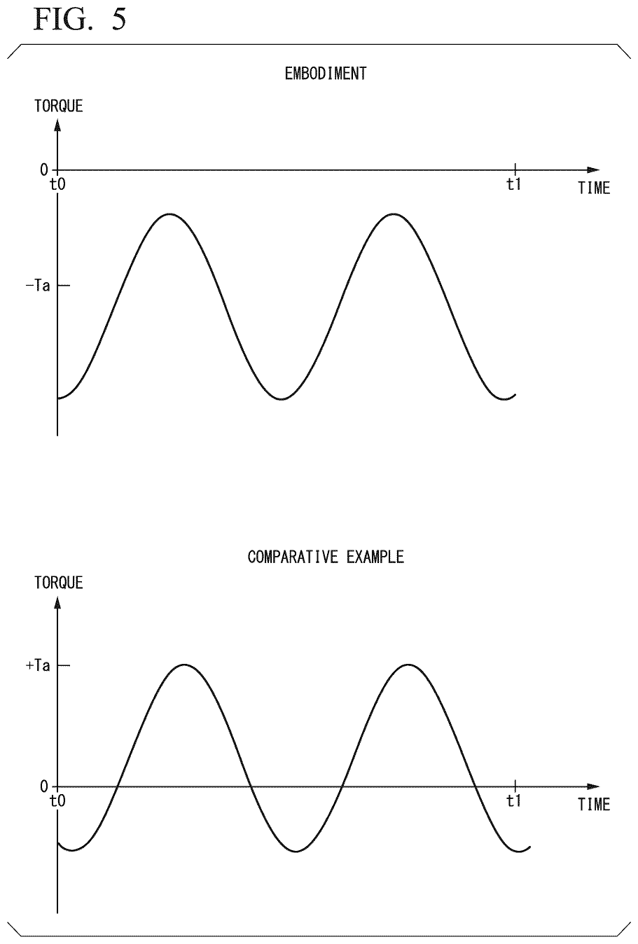

FIG. 5 is a graph view showing an example of a time change of a torque of a drive shaft in each of the embodiment and a comparative example. The torque shown in FIG. 5 is, for example, a torque of right and left drive shafts connected to the rotor 41 in a vehicle on which the electric apparatus 10 is mounted. The embodiment corresponds to the case where there is superposition of the target DC component at the time of AC charging, and the comparative example corresponds to the case where there is no superposition of the target DC component at the time of AC charging.

As shown in FIG. 5, the torque of the comparative example straddles zero periodically. On the other hand, the torque of the embodiment, is set so as not to straddle zero caused by the superposition of the target DC component. In the embodiment, since the inversion of the torque is not generated, even when the vibration of the rotor 41 occurs, generation of an impact sound such as a tooth striking sound of a gear in the power transmission mechanism connected to the rotor 41 is prevented.

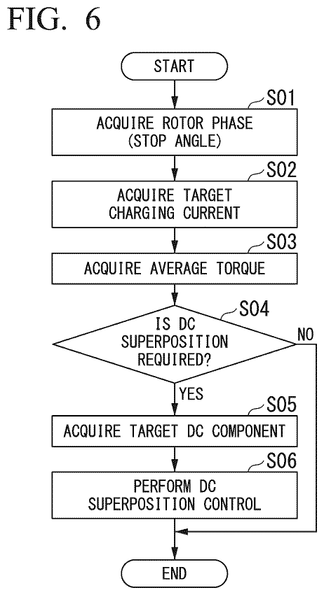

FIG. 6 is a flowchart showing an operation of the electric apparatus 10 in the embodiment.

First, in Step S01 shown in FIG. 6, the electronic control unit 18 acquires a stop phase (stop angle) of the rotor 41 that is output from the angle sensor 51 at the time of stopping of the rotary electric machine 16 (M).

Next, in Step S02, the electronic control unit 18 acquires a target charging current, for example, corresponding to the case where the efficiency of AC charging is maximized or the like.

Next, in Step S03, the electronic control unit 18 acquires, on the basis of the stop phase of the rotor 41 and the target charging current, an average torque corresponding to the stop phase of the rotor 41 and the target charging current, for example, with reference to an average torque map stored in advance or the like.

Next, in Step S04, the electronic control unit 18 determines whether or not DC superposition is required in accordance with the acquired average torque. When the determination result is “NO”, the electronic control unit 18 advances the process to the end. On the other hand, when the determination result is “YES”, the electronic control unit 18 advances the process to Step S05.

Next, in Step S05, the electronic control unit 18 acquires a target DC component, for example, by a map search or the like of a predetermined map based on the stop phase of the rotor 41, the target charging current, and the like.

Next, in Step S06, the electronic control unit 18 operates the regulation mechanism 52 that regulates power transmission in the power transmission mechanism connected to the rotor 41 and charges the electric power storage device 11 by an electric power conversion operation based on the target charging current on which the target DC component is superposed. Then, the process proceeds to the end.

As described above, according to the electric apparatus 10 of the embodiment, in the case of a stop phase in which positive and negative torques are largely generated at the rotor 41 in a state where an AC current is supplied to the β-phase coils 33 (β1, 34 (β2) of the rotary electric machine 16 (M), by providing an offset in a current value, it is possible to prevent generation of an impact sound such as a tooth striking sound of a gear due to torque pulsation. On the other hand, in the case of a stop phase in which positive and negative torques are not largely generated at the rotor 41, by not providing an offset in a current value, it is possible to prevent a decrease of charging efficiency without increasing a current effective value.

By including the regulation mechanism 52, it is possible to prevent generation of rotation caused by the target DC component at the power transmission mechanism connected to the rotor 41.

A DC voltage rectified by the AC electric power source input phase can be converted by the DC conversion phase, and the electric power storage device 11 can be charged. For example, in the case of a voltage increase operation, it is possible to perform rapid charging with respect to the voltage of the electric power storage device 11 that is larger than the charging voltage by the external AC electric power source.

At the time of driving of the rotary electric machine 16 (M) by the electric power storage device 11, the electric power control unit 10a can function as an inverter of a quadruple full-bridge circuit. At the time of DC charging of the electric power storage device 11 by the external electric power source, the combination of each coil of the rotary electric machine 16 (M) and each full-bridge circuit can function as a non-insulation type DC-DC converter. At the time of AC charging of the electric power storage device 11 by the external electric power source, the combination of the α-phase coils 23 (α1), 24 (α2) of the rotary electric machine 16 (M), the first full-bridge circuit 12a, and the second full-bridge circuit 12b can function as an insulation-type bidirectional DC-DC converter.

The combination of the B-phase coils 33 (β1), 34 (β2) and the third and fourth full-bridge circuits 13a, 13b can function as a rectification circuit. For example, in the case of the voltage increase operation at the time of AC charging, it is possible to perform rapid charging with respect to the voltage of the electric power storage device 11 that is larger than the charging voltage by the external electric power source.

### Modification Example

Hereinafter, modification examples of the embodiment will be described. The same parts as those of the above-described embodiment are denoted by the same reference numerals, and descriptions thereof are omitted or simplified.

The above embodiment is described using an example in which each of the α-phase first coil 23 (α1), the α-phase second coil 24 (α2), the β-phase first coil 33 (β1), and the β-phase second coil 34 (β2) is wound around the different teeth of the stator core 42; however, the embodiment is not limited thereto.

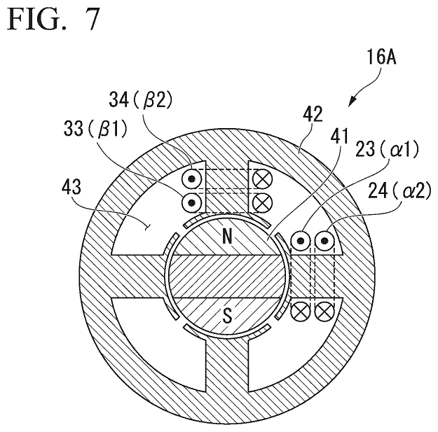

FIG. 7 is a configuration view of a rotary electric machine 16A of the electric apparatus 10 in a modification example of the embodiment.

As shown in FIG. 7, the a-phase first coil 23 (α1) and the a-phase second coil 24 (α2) may be wound around the same teeth of the stator core 42, and the β-phase first coil 33 (β1) and the β-phase second coil 34 (β2) may be wound around the same teeth of the stator core 42.

In the embodiment described above, the electronic control unit 18 may change the target DC component to an increase tendency, for example, in accordance with an increase of an angle between the AC electric power source input phase and a q-axis of the rotor 41.

The above embodiment is described using an example in which the β-phase first coil 33 (β1) and the β-phase second coil 34 (β2) are magnetically coupled to each other in the same polarity; however, the embodiment is not limited thereto. The β-phase first coil 33 (β1) and the β-phase second coil 34 (β2) may be magnetically coupled to each other in an opposite polarity. In this case, for example, a connection-disconnection device connected between one end of the β-phase first coil 33 (β1) and the neutral point R2 of the second phase of the third full-bridge circuit 13a or a connection-disconnection device connected between one end of the β-phase second coil 34 (β2) and the neutral point R3 of the first phase of the fourth full-bridge circuit 13b may be provided.

The above embodiment is described using an example in which at the time of AC charging, the current flows from the external AC electric power source to the β-phase first coil 33 (β1) and the β-phase second coil 34 (β2); however, the embodiment is not limited thereto. For example, at least one of a connection-disconnection device that switches between ON (conduction) and OFF (cutoff) of the connection between the AC electric power source connection portion 15 and the β-phase first coil 33 (β1) and a connection-disconnection device that switches between ON (conduction) and OFF (cutoff) of the connection between the AC electric power source connection portion 15 and the β-phase second coil 34 (β2) may be provided. In this case, a current may be set to flow only through the β-phase first coil 33 (β1) or the β-phase second coil 34 (β2).

The above embodiment is described using an example in which, as a parallel pattern, the DC electric power source connection portion 14 is connected to the negative electrode of the second electric power conversion portion 13 and to the neutral point (that is, between the two transistors connected reversely in series) of each of the first switch 22 and the second switch 32; however, the embodiment is not limited thereto. For example, as a serial pattern, the DC electric power source connection portion 14 may be connected to the negative electrode of the second electric power conversion portion 13 and to the neutral point Q4 of the first electric power conversion portion 12 and the neutral point R4 of the second electric power conversion portion 13. For example, as another parallel pattern, the DC electric power source connection portion 14 may be connected to the negative electrode of the second electric power conversion portion 13 and to the neutral points Q2, Q4 of the first electric power conversion portion 12 and the neutral points R2, R4 of the second electric power conversion portion 13.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and the gist of the invention and are also included within the scope of the invention described in the appended claims and equivalents thereof.

What is claimed is:

1. An electric apparatus comprising:
an electric power storage device;
a rotary electric machine having a rotor and a plurality of coils;
an electric power control unit that is connected to the electric power storage device and one or more of the plurality of coils and controls electric power transfer of each of the electric power storage device and the rotary electric machine; and
a phase acquisition portion that acquires a phase of the rotor,
wherein the electric power control unit acquires a target DC component of a current that flows through the coils by electric power supplied from an external electric power source in accordance with a stop phase of the rotor acquired by the phase acquisition portion at a time of stopping of the rotary electric machine and charges the electric power storage device by an electric power conversion operation based on the target DC component.

2. The electric apparatus according to claim 1,
wherein the one or more of the plurality of coils form an AC electric power source input phase connected to an external AC electric power source,
the electric apparatus comprises an electric power source connection member that connects the electric power control unit and the one or more of the plurality of coils to the external AC electric power source, and
the electric power control unit changes the target DC component to an increase tendency in accordance with an increase of an angle between the AC electric power source input phase and a q-axis of the rotor.

3. The electric apparatus according to claim 1, comprising:
a regulation mechanism that regulates power transmission in a power transmission mechanism connected to the rotor.

4. The electric apparatus according to claim 1,
wherein the one or more of the plurality of coils are a first phase coil that forms an AC electric power source input phase connected to an external AC electric power source,
the plurality of coils comprise a plurality of second phase coils that form a DC conversion phase used for conversion between DC electric power, and
the electric power control unit controls the conversion between DC electric power by a combination with the plurality of second phase coils.

5. The electric apparatus according to claim 4, comprising:
an electric power source connection member that connects the electric power control unit and the one or more of the plurality of coils to an external AC electric power source,
wherein the plurality of second phase coils comprises an open-ended first coil and an open-ended second coil,
the rotary electric machine comprises a stator core on which a slot shared by the first coil and the second coil is formed,
the electric power control unit comprises:
a first full-bridge circuit that is connected to both ends of the first coil;
a second full-bridge circuit that is connected to both ends of the second coil;
one or more third full-bridge circuits that are connected to both ends of one or more first phase coils;
a first connection-disconnection device that is connected between positive electrodes of the first full-bridge circuit and the second full-bridge circuit;
a second connection-disconnection device that is connected between negative electrodes of the first full-bridge circuit and the second full-bridge circuit; and
at least one third connection-disconnection device that is connected between one end of the one or more first phase coils and the one or more third full-bridge circuits, and
the electric power source connection member is connected to both ends of the third connection-disconnection device.

6. The electric apparatus according to claim 2,
wherein the one or more of the plurality of coils are a first phase coil that forms an AC electric power source input phase connected to an external AC electric power source,
the plurality of coils comprise a plurality of second phase coils that form a DC conversion phase used for conversion between DC electric power, and
the electric power control unit controls the conversion between DC electric power by a combination with the plurality of second phase coils.

7. The electric apparatus according to claim 6, comprising:
an electric power source connection member that connects the electric power control unit and the one or more of the plurality of coils to an external AC electric power source,
wherein the plurality of second phase coils comprise an open-ended first coil and an open-ended second coil,
the rotary electric machine comprises a stator core on which a slot shared by the first coil and the second coil is formed,
the electric power control unit comprises:
a first full-bridge circuit that is connected to both ends of the first coil;
a second full-bridge circuit that is connected to both ends of the second coil;
one or more third full-bridge circuits that are connected to both ends of one or more first phase coils;
a first connection-disconnection device that is connected between positive electrodes of the first full-bridge circuit and the second full-bridge circuit;
a second connection-disconnection device that is connected between negative electrodes of the first full-bridge circuit and the second full-bridge circuit; and
at least one third connection-disconnection device that is connected between one end of the one or more first phase coils and the one or more third full-bridge circuits, and
the electric power source connection member is connected to both ends of the third connection-disconnection device.

8. The electric apparatus according to claim 3,
wherein the one or more of the plurality of coils are a first phase coil that forms an AC electric power source input phase connected to an external AC electric power source,
the plurality of coils comprise a plurality of second phase coils that form a DC conversion phase used for conversion between DC electric power, and
the electric power control unit controls the conversion between DC electric power by a combination with the plurality of second phase coils.

9. The electric apparatus according to claim 8, comprising:
an electric power source connection member that connects the electric power control unit and the one or more of the plurality of coils to an external AC electric power source,
wherein the plurality of second phase coils comprises an open-ended first coil and an open-ended second coil,
the rotary electric machine comprises a stator core on which a slot shared by the first coil and the second coil is formed,
the electric power control unit comprises:
a first full-bridge circuit that is connected to both ends of the first coil;
a second full-bridge circuit that is connected to both ends of the second coil;
one or more third full-bridge circuits that are connected to both ends of one or more first phase coils;
a first connection-disconnection device that is connected between positive electrodes of the first full-bridge circuit and the second full-bridge circuit;
a second connection-disconnection device that is connected between negative electrodes of the first full-bridge circuit and the second full-bridge circuit; and
at least one third connection-disconnection device that is connected between one end of the one or more first phase coils and the one or more third full-bridge circuits, and
the electric power source connection member is connected to both ends of the third connection-disconnection device.

10. An electric apparatus control method which is a control method of an electric apparatus that comprises:
an electric power storage device;
a rotary electric machine having a rotor and a plurality of coils;
an electric power control unit that is connected to the electric power storage device and one or more of the plurality of coils and controls electric power transfer of each of the electric power storage device and the rotary electric machine; and
a phase acquisition portion that acquires a phase of the rotor, the electric apparatus control method including:
when electric power is supplied to the electric power storage device via the one or more of the plurality of coils and the electric power control unit from an external AC electric power source,
acquiring a stop phase of the rotor at a time of stopping of the rotary electric machine by the phase acquisition portion;
acquiring a target DC component superposed on a target current of a current that flows through the coils by electric power supplied from the external AC electric power source in accordance with the stop phase of the rotor; and
charging the electric power storage device by an electric power conversion operation based on the target current on which the target DC component is superposed.
